(19) United States
(12) Patent Application Publication
(10) Pub. No.: US 2012/0111213 A1
(43) Pub. Date: May 10, 2012

(54) PROCESS FOR THE PRODUCTION OF DECORATED SOLID PARTS FROM A TRANSFER FILM AND A FIXTURE FOR FACILITATING THE PROCESS

(75) Inventors: Tim Holloway, White, GA (US); Erin Grope, Ball Ground, GA (US); Jason Moore, Mableton, GA (US); Craig Zadak, Jasper, GA (US)

(73) Assignee: ROYSTON, LLC, Jasper, GA (US)

(21) Appl. No.: 13/290,781

(22) Filed: Nov. 7, 2011

Related U.S. Application Data
(60) Provisional application No. 61/410,644, filed on Nov. 5, 2010.

(51) Int. Cl. B41F 1/30; B41L 35/14

(52) U.S. Cl. 101/408; 101/488

(57) ABSTRACT

A process for adhering a decorative pattern to a flat or multi-dimensional solid involves a heat transfer powder that is sprayed or brushed onto the surface to which the image is to be applied. A design in sublimate ink is placed on a transfer film. The ink particles convert directly to gas without passing through a liquid state. The gas converts directly to a solid upon cooling filling in the gaps or pores in the heat transfer polymer. A rigid fixture is provided which has a top, front and sides onto to which solid to be decorated are snugly fit by the fixture. A solid cap which may have a soft felt-type material on the inside, which is designed to push the film in tight and level contact with the solid surface to which the design is to be imprinted may be used.

This application is a utility application that claims priority to co-pending U.S. Provisional Patent Application entitled, “PROCESS FOR THE PRODUCTION OF DECORATED MULTI-DIMENSIONAL METAL PARTS FROM A TRANSFER FILM AND FIXTURES FACILITATING THE PROCESS”, having Ser. No. 61/410,644, filed Nov. 5, 2010, which is entirely incorporated herein by reference.

### FIELD OF THE INVENTION

A process for decorating solid pieces with a pattern, especially multi-dimensional solid pieces made from metal, and a fixture for firmly holding the solid piece with the transfer polymer and the transfer film with a sublimation ink defining the pattern together during the heating process.

### BACKGROUND

Decoration of solid pieces, such as those made from metal is frequently difficult to attain. This is partly because many metal pieces that one wants to decorate are often multi-dimensional in shape. This is especially true of metal shelves which usually have a top, front and a couple of sides that need to be decorated. It is especially desirable to be able to decorate a metal shelf so that it looks like wood or marble which has a more attractive appearance to viewers. Metal cabinets are especially difficult to decorate with a pattern because of the number of surfaces involved.

### BRIEF DESCRIPTION OF THE DRAWINGS

FIG. 1 is an exploded view of a shelf and fixture used to firmly hold the shelf with a heat transfer polymer onto which the pattern is to be transferred and the transfer film during the heating process to achieve the transfer.

### DETAILED DESCRIPTION OF THE PREFERRED EMBODIMENT

Referring now in detail to the drawing, it shows a process for the decoration of multi-dimensional metal pieces utilizing the technique of transfer of a pattern reproduced on film by means of subjecting it to an elevated temperature. This transfer process is carried out by placing a flat or multi-dimensional solid piece, such as metal (e.g. rolled steel), on an aluminum fixture as shown in the drawing. This solid piece may be a flat sheet, or a multidimensional piece. This metal piece has been sprayed with a transfer polymer, such as a polyurethane powder or a polyester powder, as a base coat for the heat transfer process. The film with pattern is carefully placed over the portion of the metal piece on which the pattern is to be printed. An aluminum cap with a felt-like lining is then placed over the multi-dimensional metal piece and adhered to it by clamps and straps or other means for holding the metal piece and transfer materials secure during the process. This combination of the aluminum fixture, metal piece and aluminum cap is then placed in an oven and heated for a desired period of time to affix the pattern to the metal piece. This metal piece is then removed and the film removed. It may be necessary to cool the metal piece before removing the film.

### PARTS LIST

12 Aluminum base;
14 Shelf;
18 Film with pattern;
20 Tape;
22 Aluminum cap assembly;
23 Sides of fixture;
24 Hinges;
26 Felt-like layer;
28 Assembly clamp;
30 Torsion clamp;
32 Aperture for torsion clamp;

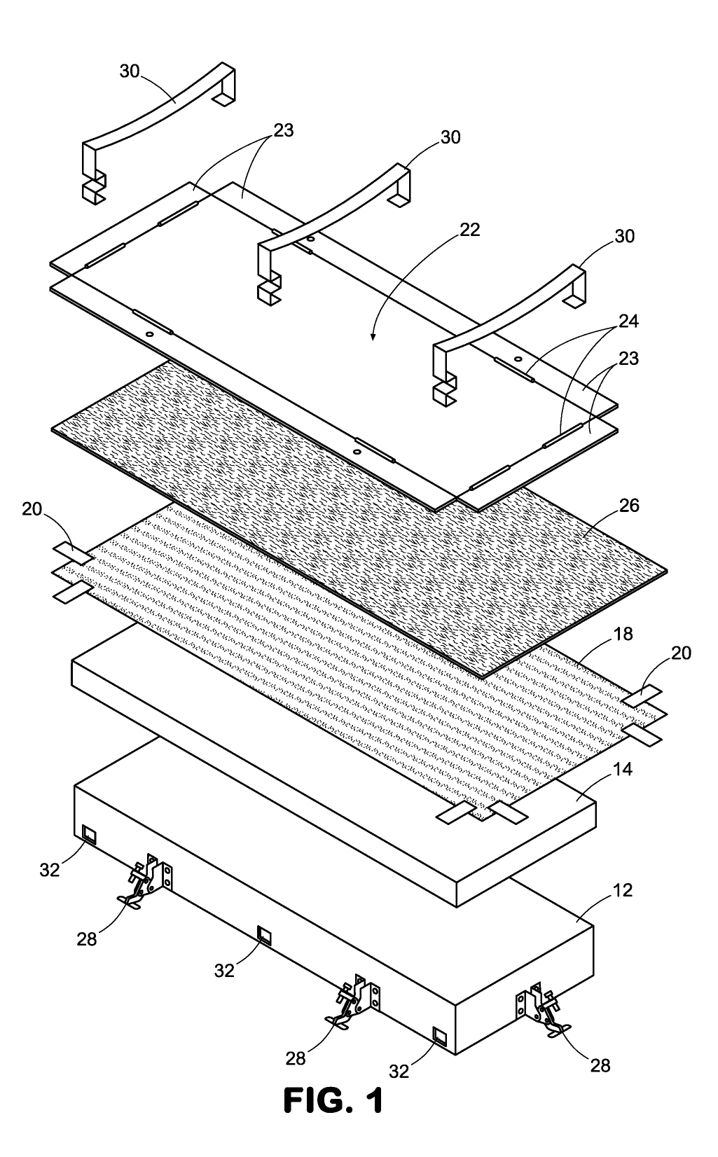

The shelf 14 as shown in FIG. 1 is first prepared by spraying or brushing a heat transfer polymer, such as a polyurethane powder or a polyester powder, onto the parts of the shelf on which a pattern is to be applied.

After spraying, the shelf is heated for a period of time, such as 375° Fahrenheit for twenty minutes, so that the polymer adheres to the shelf. During this period of time the transfer powder polymerizes and adheres to the metal surfaces of the shelf. Holes can be provided in the shelf to hold dividers or other elements.

In order to hold the transfer film 18 and the shelf 14 in firm contact during the heating process, an aluminum fixture has been developed. The fixture as shown in FIG. 1 has an aluminum base 12 onto which the metal shelf 14 is placed.

The image to be placed on the shelf is contained on a preprinted film 18 which is preferably a polyester film that is nonporous. This pattern can be printed on the film using an ink that sublimates by an inkjet printer or by a rotogravure press. This pattern can be a wood grain or type of marble or other type of pattern. After the film 18 has been cut, it is placed in alignment over the part of the shelf on which a pattern is desired to be printed as shown in FIG. 1. The film 18 is held in place by tape 20 or other means.

The next step in the process is to place an aluminum cap 22 over the shelf 14 with the transfer powder and ink and the film 18 with the pattern. This cap 22 may have a felt-like material 26 on the bottom of the cap or as a separate layer. This felt-like material 26 is placed on top of the film 18. The felt serves the purpose of ensuring that the film 18 is flat and even on the surfaces of the metal to be decorated. A felt made of a cotton polyester blend that will withstand the temperature of the oven is needed. The cap 22 holds the film 18 securely to the metal piece 14 coated with polyurethane or polyester transfer polymer.

In the next step the aluminum cap assembly 22 is strapped tightly to the base 12 on which the shelf 14 rests. The cap assembly 22 has sides 23 which are hinged to the assembly by hinges 24. The assembly must be held tightly together during the heating process. Two or more assembly clamps 28 may be used to hold the sides 23 of the assembly tightly together. Two or three torsion clamps 30 may be used to hold the center portions of the assembly tightly together. These torsion clamps 30 may extend over the top of the assembly and secured in apertures 32 to hold it tightly together. For ease of assembling the shelf in the aluminum fixture, the base 12 may be placed on a cart for the assembly process.

It should be understood that the assembly can be constructed of other types of material to hold the shelf and transfer materials together during heating. Aluminum is preferred because of its ability to transfer heat to the transfer materials and shelf or other material to be printed. Devices other than assembly clamps and torsion clamps can be used to hold the shelf and transfer material and film together during heating.

After the assembly has been completed, it is then loaded onto a trolley or belt for moving into an oven. The oven may be either an electric or gas oven. A convection oven is preferred. The Decoral® 501 convection oven is preferred. Preferably the heating in the oven is at about 400° for approximately twenty minutes. This heating results in the ink sublimating into a gas into the polyurethane or polyester layer and imprinting an image.

At the end of the cycle, the shelf being held together by an aluminum base 12 and cap assembly 22, are removed from the oven. This assembly may then be placed in front of a fan to cool the shelf. The shelf is unclamped and the film 18 removed from the shelf.

The carts used in this process and the aluminum fixture can be reused and stored on the cart.

This process can be used with any type of solid shelf. A wood grain or other type of pattern can be imparted to the top, sides and front of a shelf as shown in FIG. 1. Other types of images can be imprinted onto the shelf, such as a name or another type of pattern. This process is very economical because the carts, aluminum base and aluminum cap can be used repeatedly to make a large number of decorated metal items of the same or similar configuration.

Uniformity of the pressure is exerted onto the shelf by clamping the aluminum base 12 to the cap assembly 22. An excellent pattern can be imprinted on the metal shelf. It is necessary that the pressure be uniform to hold the film to the metal piece. This is achieved by the strapping and clamping process and also by the use of a felt like material to make sure that the film is flat against the surfaces to be imprinted. The heat of the oven needs to be controlled to produce the desirable imprint on the polyurethane or polyester powder and ink.

The process of this invention can be used to print a pattern on many different types of store fixtures in addition to shelves. The process can be used to print a pattern on a frame, back panel, deck and also on almost any type of metal. The process can be used to print a pattern onto retail store merchandising displays, cabinets (including both internal and external components) countertops, belted and non-belted checkstands and checkout counters, self-checkout stands, refrigerated and heat merchandisers, salad bars, olive bars and seafood cases, outdoor merchandisers and gas pump island valets.

Almost any type of pattern may be printed with this process. Wood grain including the proper color and marble type surface can be printed. Almost any type of motif can be printed, such as flowers, dots etc.

This process may be printed on almost any type of solid material, including coated aluminum, glass, plastic, wood, stone and ceramics.

What is claimed is:

1. A process for creating a pattern on the surface of a solid material consisting essentially of the following steps in sequence:
a. Printing the desired image with a pattern in a sublimate ink on a film;
b. Coating the surfaces of the solid material on which the pattern is to be imprinted with a heat transfer polymer powder;
c. Heating the polymer and solid material to affix the powder to the solid material;
e. Placing the solid material with polymer and film on a fixture to hold them securely in place;
f. Placing a holding cap over the film and solid material and attaching the cap to the fixture thereby exerting pressure on the film and solid material to hold the film in place on the solid material for printing;
g. Heating the solid material with the polymer and film for a sufficient time and temperature to affix the image to the solid material; and
h. Removing the solid material with the polymer and film from the heating source and removing the film to reveal the solid material with pattern printed on the desired surfaces of the solid material.

2. The process of claim 1 in which the solid material is rolled steel with multidimensional surfaces.

3. The process of claim 1 in which the cap has a felt-like material on the inside to assist in keeping the film flat and under uniform pressure on the solid material.

4. The process of claim 1 in which the solid material is a metal shelf with multidimensional surfaces to be decorated.

5. The process of claim 1 in which the solid material and film are heated in a convection oven.

6. The process of claim 1 in which the solid material with the pattern printed on the polymer on the solid surface are cooled to facilitate the setting of the pattern on the polymer prior to removing the holding cap.

7. The process of claim 1 in which the transfer polymer is a polyester.

8. The process of claim 1 in which the transfer polymer is a polyurethane.

9. The process of claim 2 in which the transfer polymer is a polyester.

10. The process of claim 2 in which the transfer polymer is a polyurethane.

11. A process for creating a pattern on the surface of a metal piece consisting essentially of the following steps in sequence:
a. Printing the desired image with a pattern in a sublimation ink on a transfer film;
b. Coating the surfaces of the metal on which the pattern is to be imprinted with a heat transfer polyester polymer powder;
c. Heating the polymer and metal to affix the polymer to the metal;
d. Placing the metal piece with polymer on a fixture to hold it securely in place;
e. Placing the film with the image over the surface of the metal to be printed and securing it in place by securing means;
f. Placing a holding cap over the film and metal and attaching the cap to the fixture thereby exerting pressure on the film and metal to hold the film in place on the metal for printing;
g. Heating the metal with the polymer and film for a sufficient time and temperature to affix the image to the metal; and
h. Removing the metal with the polymer and film from the heating source and removing the film to reveal the metal with the pattern printed on the desired surfaces of the metal.

12. A process for creating a pattern on the surface of a metal piece consisting essentially of the following steps in sequence:
a. Printing the desired image with a pattern in a sublimation ink on a film;
b. Coating the surfaces of the metal on which the pattern is to be imprinted with a heat transfer polyurethane polymer powder;
c. Heating the polymer and metal to affix the polymer to the metal;
d. Placing the metal piece with polymer on a fixture to hold it securely in place;
e. Placing the film with the image over the surface of the metal to be printed and securing it in place by securing means;
f. Placing a holding cap over the film and metal and attaching the cap to the fixture thereby exerting pressure on the film and metal to hold the film in place on the metal for printing;
g. Heating the metal with the polymer and film for a sufficient time and temperature to affix the image to the metal; and
h. Removing the metal with the polymer and film from the heating source and removing the film to reveal the metal with the pattern printed on the desired surfaces of the metal.

13. A reusable heat resistant fixture for holding a solid material secure to permit the creation of a pattern on the surface of the solid material consisting essentially of:
a. The fixture having a base with a flat top, sides, front on which the solid material can be placed with the surfaces of the material on which the pattern is to be created facing away from the base;
b. A reusable rigid cap having a flat top surface, sides, and front, which will fit snugly over the solid material on which the pattern is to be created, with the cap having a soft material or layer on the inside to help keep the surface of the solid material and the film on which the pattern is to be transferred flat and even;
c. Means to secure and exert pressure on the film and surface of the solid material to hold the film securely to the solid material during a heating process for transferring of the pattern to the solid material.

14. The apparatus of claim 13 in which the fixture is made of aluminum.

15. The apparatus of claim 13 in which the soft material inside the cap is a felt-like material.

16. The apparatus of claim 13 in which the means (c) to exert pressure on the film and surface of the solid material is a plurality of clamps for holding the base and top cap of the fixture tight and secure to each other.

17. The apparatus of claim 14 in which the means (c) to exert pressure on the film and surface of the solid material is a plurality of clamps for holding the base and top cap of the fixture tight and secure to each other.
